(19) United States
(12) Patent Application Publication
(10) Pub. No.: US 2025/0097880 A1
(43) Pub. Date: Mar. 20, 2025

(54) TERMINAL AND WIRELESS TRANSMISSION CONTROL METHOD THEREFOR

(71) Applicant: SONY GROUP CORPORATION, TOKYO (JP)

(72) Inventor: MASANORI SATO, TOKYO (JP)

(21) Appl. No.: 18/727,118

(22) PCT Filed: Nov. 18, 2022
(86) PCT No.: PCT/JP2022/042844

§ 371 Date: Jul. 8, 2024

(30) Foreign Application Priority Data
Jan. 14, 2022 (JP) 2022-004325

(51) Int. Cl. H04W 64/00

(52) U.S. Cl. CPC H04W 64/00

(57) ABSTRACT

A reception success rate of a signal transmitted from a terminal in a satellite receiving station is improved. A terminal positioning unit acquires a terminal position that is a current position of the terminal and current time. A satellite positioning unit acquires a satellite position that is a current position of the satellite receiving station on the basis of the current time. A transmission period determination unit determines a transmission period on the basis of the terminal position and the satellite position. A wireless resource determination unit determines a transmission timing and a transmission frequency as wireless resources on the basis of the current time, a terminal identifier of the terminal, and the determined transmission period. A transmission control unit controls wireless transmission in accordance with the determined transmission timing and transmission frequency.

### TECHNICAL FIELD

The present technology relates to a terminal that performs wireless communication. Specifically, the present technology relates to a terminal that periodically performs wireless transmission and a wireless transmission control method therefor.

### BACKGROUND ART

In the Internet of Things (IoT) related technology, it is expected that information on mountainous areas and seas, which has been difficult to acquire conventionally, can be acquired. It is expected that it is possible to grasp environmental changes and prevent disasters by performing observations of the mountainous areas and the seas. On the other hand, the installation of receiving stations is a problem. This is because, since the number of terminals is expected to be smaller in a mountainous area or the like than in an urban area, the cost of installing and operating the receiving station for a small number of terminals is increased. Furthermore, in the sea or the like, installation itself of the receiving station is difficult. Therefore, a wireless system using a satellite receiving station in which a receiving station is mainly mounted on a low earth orbit satellite is studied. Reality of such wireless system is increasing due to the advent of the wireless technology for IoT capable of long-distance communication, the reduction in the cost of launching small satellites, and the like. By constructing a wireless system in which a ground receiving station and a satellite receiving station are combined, it is possible to construct a wireless system capable of acquiring information from any place on the earth at low cost. Therefore, for example, a method in which a terminal on the ground periodically transmits sensor information has been proposed (see, for example, Patent Document 1.).

### CITATION LIST

### Patent Document

Patent Document 1: WO 2020/246158 A

### SUMMARY OF THE INVENTION

### Problems to be Solved by the Invention

In the above-described related art, it is possible for a terminal to transmit sensor information, for example, in a period of 30 minutes. This transmission signal is received by the ground receiving station or the satellite receiving station, whereby a wireless system combining the ground receiving station and the satellite receiving station can be constructed. However, since the satellite receiving station is moving at a very high speed, it is difficult in some cases to receive periodically transmitted transmission signals. For example, since a satellite at an altitude of 400 Km moves at a speed of 7 Km per second and moves by 12, 600 Km in 30 minutes, a communication distance becomes long, and transmission may not be performed in a receivable range.

The present technology has been made in view of such a situation, and an object of the present technology is to improve a reception success rate of a signal transmitted from a terminal in a satellite receiving station.

### Solutions to Problems

The present technology has been made to solve the above-described problems, and a first aspect thereof is a terminal and a wireless transmission control method therefor, the terminal including: a terminal positioning unit that acquires a terminal position that is a current position of a terminal and current time; a satellite positioning unit that acquires a satellite position that is a current position of a satellite receiving station on the basis of the current time; a transmission period determination unit that determines a transmission period on the basis of the terminal position and the satellite position; a wireless resource determination unit that determines a transmission timing and a transmission frequency as wireless resources on the basis of the current time, a terminal identifier of the terminal, and the transmission period; and a transmission control unit that controls wireless transmission in accordance with the transmission timing and the transmission frequency. This brings about an effect that the transmission period from the terminal is determined depending on the positional relationship with the satellite receiving station.

Furthermore, in the first aspect, the transmission period determination unit may determine, as a terminal-to-satellite distance is shorter, at least a period that is not long as the transmission period, the terminal-to-satellite distance being an absolute value of a difference between the terminal position and the satellite position. This brings about an effect that the transmission period is made shorter when the distance to the satellite receiving station becomes shorter.

Furthermore, in the first aspect, in a case where the terminal-to-satellite distance is shorter than a predetermined threshold, the transmission period determination unit may determine, as the transmission period, a period shorter than a period in a case where the terminal-to-satellite distance is longer than the threshold. This brings about an effect that the transmission period is made shorter when the distance to the satellite receiving station becomes shorter than the threshold.

Furthermore, in the first aspect, the transmission period determination unit may determine, in a case where the terminal-to-satellite distance is shorter than a first threshold, a first period as the transmission period, the first period being shorter than a period in a case where the terminal-to-satellite distance is longer than the first threshold, and may determine, in a case where the terminal-to-satellite distance is longer than the first threshold and is shorter than a second threshold that is longer than the first threshold, a second period as the transmission period, the second period being shorter than a period in a case where the terminal-to-satellite distance is longer than the second threshold. This brings about an effect that the transmission period is made shorter when the distance to the satellite receiving station becomes shorter using a plurality of thresholds.

Furthermore, in the first aspect, the transmission period determination unit may determine a predetermined initial transmission period as the transmission period at a beginning of transmission, determines a period shorter than the initial transmission period as the transmission period in a case where the terminal-to-satellite distance becomes shorter than a predetermined threshold, and may determine a period longer than the initial transmission period as the transmission period in a case where the terminal-to-satellite distance becomes longer than the predetermined threshold. This brings about an effect that the transmission period is made shorter than the initial transmission period when the distance to the satellite receiving station becomes shorter.

Furthermore, in the first aspect, the transmission period determination unit may determine a predetermined initial transmission period as the transmission period at a beginning of transmission, may determine a period shorter than the initial transmission period as the transmission period in a case where the terminal-to-satellite distance becomes shorter than a predetermined threshold, and may determine a period longer than the initial transmission period as the transmission period in a case where the terminal-to-satellite distance becomes longer than the predetermined threshold. This brings about an effect that the transmission period is made longer than the initial transmission period when the distance to the satellite receiving station becomes longer.

Furthermore, in the first aspect, in a case where the terminal-to-satellite distance is longer than a predetermined threshold, the transmission period determination unit may determine an infinite period as the transmission period. This brings about an effect that the transmission is stopped when the distance to the satellite receiving station becomes longer.

Furthermore, in the first aspect, a battery capacity acquisition unit that acquires a current battery capacity of a battery for operating the terminal may be further provided, and the transmission period determination unit may determine the transmission period depending on the terminal-to-satellite distance and the battery capacity. In this case, in a case where the battery capacity is smaller than a predetermined capacity threshold, the transmission period determination unit may determine, as the transmission period, a period longer than a period in a case where the battery capacity is larger than the capacity threshold. This brings about an effect that the transmission period is made longer when the battery capacity becomes small.

### BRIEF DESCRIPTION OF DRAWINGS

FIG. 1 is a diagram illustrating an example of an overall configuration of a wireless system in an embodiment of the present technology.

FIG. 2 is a diagram illustrating a configuration example of a terminal 100 in the embodiment of the present technology.

FIG. 3 is a diagram illustrating a configuration example of a satellite receiving station 600 in the embodiment of the present technology.

FIG. 4 is a diagram illustrating a configuration example of time managed in the wireless system in the embodiment of the present technology.

FIG. 5 is a flowchart illustrating an example of a processing procedure of the terminal 100 in the embodiment of the present technology.

FIG. 6 is a flowchart illustrating an example of a processing procedure of a transmission period determination procedure (step S916) in a first embodiment of the present technology.

FIG. 7 is a diagram illustrating a specific example of transition of a transmission period in the first embodiment of the present technology.

FIG. 8 is a flowchart illustrating an example of a processing procedure of a satellite receiving station 600 in an embodiment of the present technology.

FIG. 9 is a flowchart illustrating an example of a processing procedure of a transmission period determination procedure (step S916) in a second embodiment of the present technology.

FIG. 10 is a diagram illustrating a specific example of transition of a transmission period in the second embodiment of the present technology.

FIG. 11 is a diagram illustrating a configuration example of the terminal 100 in a first modification of the embodiments of the present technology.

FIG. 12 is a flowchart illustrating an example of a processing procedure of a transmission period determination procedure (step S916) in a second modification of the embodiments of the present technology.

FIG. 13 is a diagram illustrating an example of a relationship between a terminal-to-satellite distance and a transmission period in the second modification of the embodiments of the present technology.

### MODE FOR CARRYING OUT THE INVENTION

Modes for carrying out the present technology (hereinafter referred to as embodiments) will be described below. The description will be given in the following order.
1. First embodiment (an example in which the transmission period is made shorter than usual as the terminal-to-satellite distance becomes shorter)
2. Second embodiment (an example in which the transmission period is made longer than usual as the terminal-to-satellite distance increases)
3. Modifications

### 1. First Embodiment

### [Wireless System]

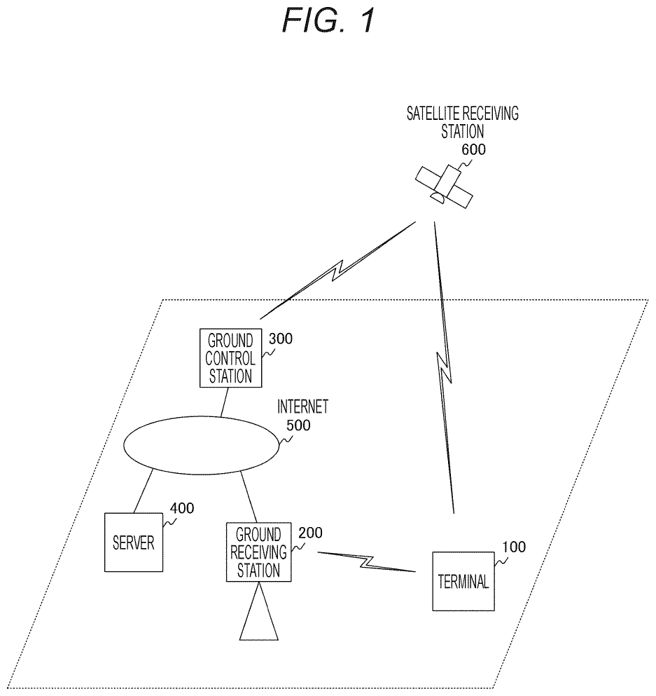

FIG. 1 is a diagram illustrating an example of an overall configuration of a wireless system in an embodiment of the present technology.

The wireless system includes a terminal 100, a ground receiving station 200, a ground control station 300, a server 400, and a satellite receiving station 600. In this wireless system, the sensor information transmitted from the terminal 100 is received by the ground receiving station 200 or the satellite receiving station 600, and the received sensor information is aggregated in the server 400.

The terminal 100 is a transmission terminal that periodically transmits the sensor information. The ground receiving station 200 is a receiving station in which a reception device is mounted on a ground facility such as a rooftop of a building. The satellite receiving station 600 is a receiving station in which a reception device is mounted on a low earth orbit satellite. The ground control station 300 is a control station that tracks and controls the satellite receiving station 600 on the ground.

The server 400 is a server that collects sensor information received by the ground receiving station 200 or the satellite receiving station 600. The ground receiving station 200 communicates with the server 400 on Internet 500 via a communication line such as a wired line. The satellite receiving station 600 communicates with the server 400 via a line of the ground control station 300.

Note that, in this example, each of the wireless devices is illustrated as one device, but each of the wireless devices may be present as a plurality of devices.

### [Terminal]

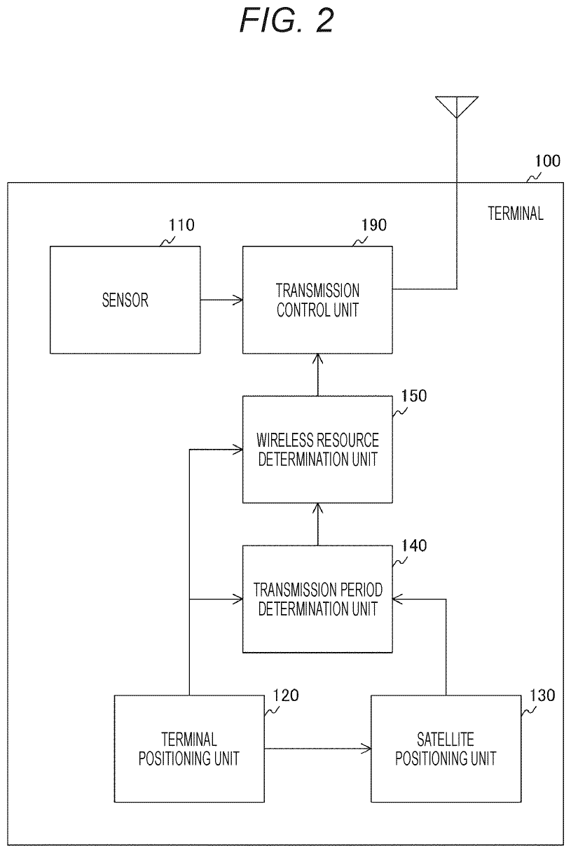

FIG. 2 is a diagram illustrating a configuration example of the terminal 100 in the embodiment of the present technology.

The terminal 100 includes a sensor 110, a terminal positioning unit 120, a satellite positioning unit 130, a transmission period determination unit 140, a wireless resource determination unit 150, and a transmission control unit 190.

The sensor 110 detects temperature, humidity, moisture, and the like, and acquires sensor information.

The terminal positioning unit 120 receives a signal from a positioning satellite of a global navigation satellite system (GNSS) such as a global positioning system (GPS), and acquires the current time and the position information of the terminal 100.

The satellite positioning unit 130 acquires position information of the satellite receiving station 600. The satellite positioning unit 130 holds satellite information of the satellite receiving station 600 by, for example, two line element set (TLE), and estimates position information of the satellite receiving station 600 from the satellite information and the current time acquired by the terminal positioning unit 120.

The transmission period determination unit 140 determines a transmission period by using the position information of the satellite acquired by the satellite positioning unit 130 and the position information of the terminal acquired by the terminal positioning unit 120. As will be described later, the transmission period determination unit 140 makes the transmission period shorter in a case where the satellite receiving station 600 is present nearby, thereby increasing the possibility that reception is performed in the satellite receiving station 600. On the other hand, in a case where the satellite receiving station 600 is present far away, the transmission period is made longer to suppress the number of times of transmission of the terminal 100 as a whole and suppress the power consumption of the terminal 100.

The wireless resource determination unit 150 determines a transmission timing and a transmission frequency as a wireless resource to be used for transmission from the terminal 100. The wireless resource determination unit 150 determines a transmission timing and a transmission frequency from the current time acquired by the terminal positioning unit 120, the terminal identifier of the terminal 100, and the transmission period determined by the transmission period determination unit 140.

The transmission control unit 190 performs control to transmit the sensor information as a wireless signal according to the transmission timing and the transmission frequency determined by the wireless resource determination unit 150.

### [Satellite Receiving Station]

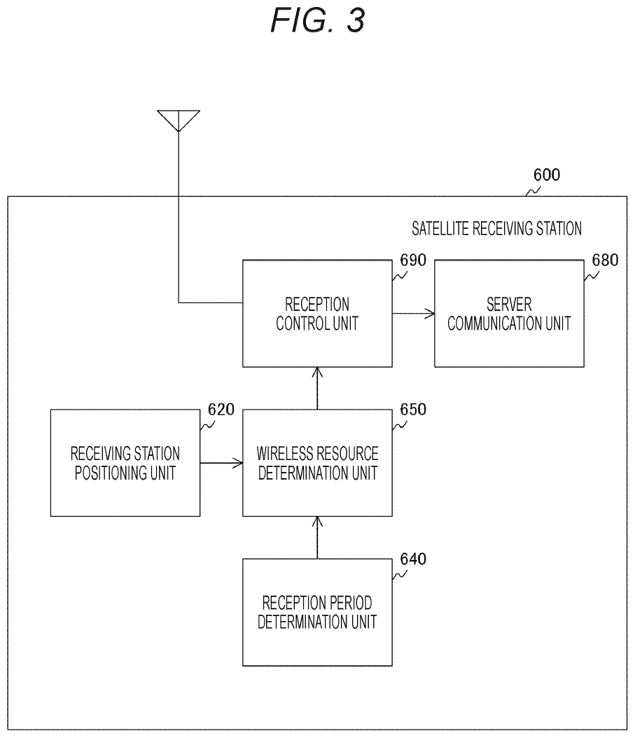

FIG. 3 is a diagram illustrating a configuration example of the satellite receiving station 600 in the embodiment of the present technology.

The satellite receiving station 600 includes a receiving station positioning unit 620, a reception period determination unit 640, a wireless resource determination unit 650, a server communication unit 680, and a reception control unit 690.

The receiving station positioning unit 620 receives a signal from a positioning satellite of a global navigation satellite system such as a GPS, and acquires current time and position information of the satellite receiving station 600.

The reception period determination unit 640 determines the minimum value of the transmission periods of the terminal 100 to be received as the reception period. The transmission period of the terminal 100 is determined at the time of service contract, and is supplied in advance from the server 400 together with the terminal identifier of the terminal 100.

The wireless resource determination unit 650 determines a reception timing and a reception frequency as wireless resources to be used for reception of a signal transmitted from the terminal 100. The wireless resource determination unit 650 determines a reception timing and a reception frequency from the current time acquired by the receiving station positioning unit 620, the terminal identifier of the terminal 100 to be received, and the reception period determined by the reception period determination unit 640.

The server communication unit 680 sends the received sensor information to the server 400. The server communication unit 680 communicates with the server 400 via a line of the ground control station 300.

The reception control unit 690 performs control to receive the sensor information as a wireless signal according to the reception timing and the reception frequency determined by the wireless resource determination unit 650.

Note that, although the configuration example of the satellite receiving station 600 has been described here, the ground receiving station 200 also has a similar configuration. However, the server communication unit in the ground receiving station 200 is configured to communicate with the server 400 on the Internet 500 via a communication line such as a wired line.

### [Determination of Transmission Timing]

The wireless resource determination unit 150 determines a transmission timing as follows from the current time acquired by the terminal positioning unit 120, the terminal identifier of the terminal 100, and the transmission period determined by the transmission period determination unit 140.

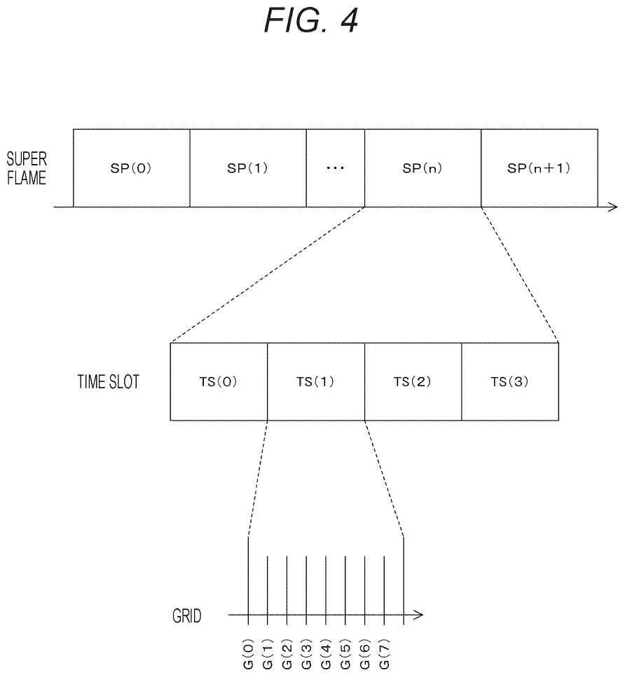

FIG. 4 is a diagram illustrating a configuration example of time managed in the wireless system in the embodiment of the present technology.

In this wireless system, time is divided into super frames (SP) of a predetermined length. Furthermore, each of the super frames is divided into a plurality of time slots (TS). Then, each of the time slots is further divided into a plurality of grids (G). Hereinafter, the serial numbers of the super frames are referred to as SP numbers.

First, from current time t acquired by the terminal positioning unit 120, the current SP number and the start time of the super frame of the SP number are determined. For example, in the case of the GPS, the time obtained from the GPS time is based on 0:00:00 on Jan. 6, 1980. Here, consideration is made as a unit of seconds.

It is assumed that the length of the super frame section is SP_{duration}. The length of the super frame section is determined in advance as a wireless system. At this time, assuming that an SP number which is a serial number of the super frame section is n and a start time of the super frame with the number n is SP (n)ₛₜₐᵣₜ₋ₜᵢₘₑ, the following equation is determined. Note that an operator div ( ) indicates a quotient of division.

$$n = div ( t , {SP}_{duration} )$$

$$SP {( n )}_{start - time} = n \times {SP}_{duration}$$

According to the above equation, the start time SP (n) start-time of the super frame SP (n) whose serial number is a quotient obtained by dividing the current time t by the super frame section SP_{duration} is a value obtained by multiplying n by the super frame section length.

Next, an SP number that can be transmitted by the terminal 100 is determined. This is determined by using a transmission period Period allocated in advance and a terminal identifier ID as information unique to the terminal 100. Since the determination is made using the terminal identifier ID which is information unique to the terminal, different SP numbers are allocated to the terminals even in the same transmission period. Here, the transmission period Period expressed in seconds is converted into the number of super frames, that is, an interval m of the SP number. Specifically, according to the following equation, a quotient obtained by dividing the transmission period Period allocated in advance by the super frame section length SP_{duration} is set as the interval m of the SP number.

m=div(Period,SP_{duration})

Next, in order to change the SP number for each terminal, an offset value m_{oft} is calculated according to the following equation. However, an operator mod ( ) in the following equation indicates the remainder of the division. That is, the remainder obtained by dividing the terminal identifier ID of the terminal 100 by the interval m of the SP number is the offset value m_{oft} of the terminal 100.

m_{oft}=mod(ID,m)

Then, the SP number (n) that can be transmitted by the terminal 100 is determined using the offset value m_{oft} obtained in this manner. Specifically, when the SP number (n) satisfies the following equation, the terminal 100 can perform transmission. That is, the terminal 100 can perform transmission in the super frame with the SP number (n) in which the value obtained by adding the offset value m_{oft} can be divided by the interval (m) of the SP number corresponding to the transmission period.

mod(n+m_{oft},m)=0

Next, the transmission time in the super frame of the SP number thus obtained is determined. It is assumed that the terminal 100 performs repetitive transmission in each time slot. The repetitive transmission is that the terminal 100 transmits the same data a plurality of times, and this can increase a success rate of communication and realize long-distance communication. The repetitive transmission is performed by the number of timeslots in the super frame. There may be one timeslot in the super frame, but in such case, repetitive transmission is not performed.

The transmission start time in each timeslot can be determined by the start time of the corresponding super frame and the number of timeslots in the super frame. Assuming that the number of divisions of the timeslot in the nth super frame SP (n) is nTS, the start time TS(k)_{start-time in SP (n)} of the kth timeslot TS(k) in the super frame is determined according to the following equation. Here, k is an integer from 0 to (nTS−1).

TS(k)_{start-time in SP(n)}=SP(n)ₛₜₐᵣₜ₋ₜᵢₘₑ+k×SP_{duration}/nTS

A plurality of transmission start times called grids is defined in the time slot. Here, it is assumed that eight start times G(0) to G(7) are defined for each time slot. The grid to be transmitted by the terminal 100 is determined by using a pseudo random number sequence. For example, by generating a 12 bit pseudo random number sequence, the grid number in the time slot is determined as the transmission time.

### [Determination of Transmission Frequency]

It is assumed that the number of frequency channels available as a wireless system is nF. Here, description will be made on the assumption of nF=4. The wireless resource determination unit 150 further generates an 8-bit pseudo random number sequence after the 12 bit pseudo random number sequence generated for determining the transmission time. Due to the relationship of nF=4, 8 bits are divided into 4 by 2, and a value obtained by converting each 2 bits into a decimal number is set as the transmission frequency number. The frequency number corresponds to the center frequency of the carrier frequency in the case of actual transmission.

In this manner, the transmission timing and the transmission frequency in a case where the terminal 100 periodically performs transmission can be determined on the basis of the current time and the terminal identifier. Since the terminal identifier is used, different time and frequency can be allocated to each terminal, and different timing and frequency can be allocated depending on the transmission time.

Note that, although the wireless resource determining method in the wireless resource determination unit 150 of the terminal 100 has been described here, the reception time and the reception frequency can be similarly determined on the basis of the current time and the terminal identifier in the ground receiving station 200 and the satellite receiving station 600.

### [Operation]

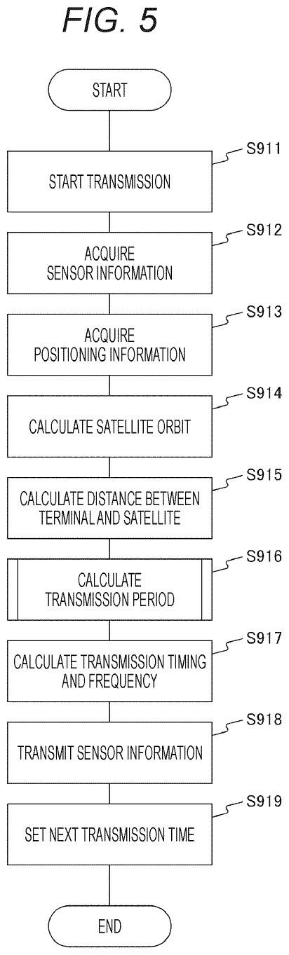

FIG. 5 is a flowchart illustrating an example of a processing procedure of the terminal 100 in the embodiment of the present technology.

Here, it is assumed that the terminal 100 performs transmission in an initial period X0 (for example, 30 minutes). It is assumed that the initial period X0 is determined at the time of service contract. In this example, the initial period X0 is assumed to be, for example, 30 minutes.

Furthermore, it is assumed that a threshold TH for making far/near judgement is held for a terminal-to-satellite distance which is a distance between the terminal 100 and the satellite receiving station 600. The threshold TH is determined in advance on the basis of a reception range determined by reception performance of the satellite receiving station 600.

Furthermore, it is assumed that a short period X1, which is a transmission period when the terminal-to-satellite distance becomes short, is determined at the time of service contract. In this example, the short period X1 is assumed to be, for example, 10 minutes.

When the terminal 100 starts the transmission operation (step S911), the operation is started after the power is turned on for the first time, and the operation is started at the timing of the transmission period from the next time.

The sensor 110 acquires sensor information (step S912).

The terminal positioning unit 120 receives a signal from the positioning satellite of the global navigation satellite system, and acquires the current time and position information of the terminal 100 (step S913).

The satellite positioning unit 130 calculates a satellite orbit from the current time acquired by the terminal positioning unit 120 and the satellite information of the satellite receiving station 600, and acquires the position information of the satellite receiving station 600 (step S914).

The transmission period determination unit 140 calculates an absolute value of a difference between the position information of the satellite acquired by the satellite positioning unit 130 and the position information of the terminal acquired by the terminal positioning unit 120 to calculate the terminal-to-satellite distance (step S915).

Furthermore, the transmission period determination unit 140 determines the transmission period by comparing the calculated terminal-to-satellite distance with the threshold TH (step S916).

On the basis of the determined transmission period, the wireless resource determination unit 150 determines a transmission timing and a transmission frequency to be used for transmission from the terminal 100 (step S917).

Then, the transmission control unit 190 performs control to transmit the sensor information as a wireless signal according to the transmission timing and the transmission frequency determined (step S918). The next transmission time is set on the basis of the determined transmission period (step S919).

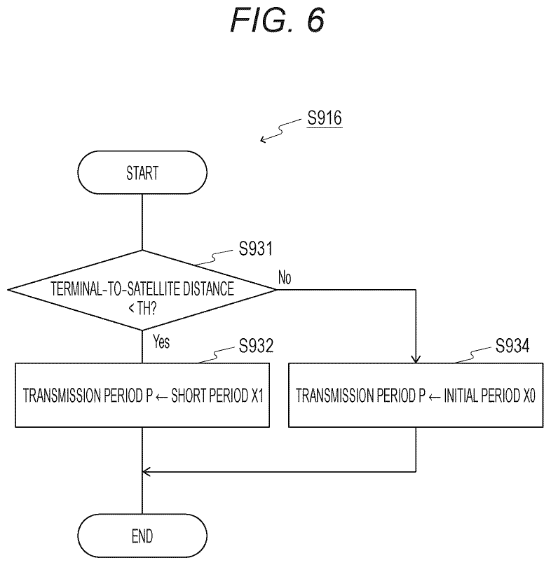

FIG. 6 is a flowchart illustrating an example of a processing procedure of a transmission period determination procedure (step S916) in the first embodiment of the present technology.

The transmission period determination unit 140 compares the terminal-to-satellite distance with the threshold TH to determine the transmission period. In a case where the terminal-to-satellite distance is not smaller than the threshold TH (step S931: No), the initial period X0 is set as the transmission period P (step S934). On the other hand, when the terminal-to-satellite distance becomes smaller than the threshold TH (step S931: Yes), the short period X1 is set as the transmission period P (step S932).

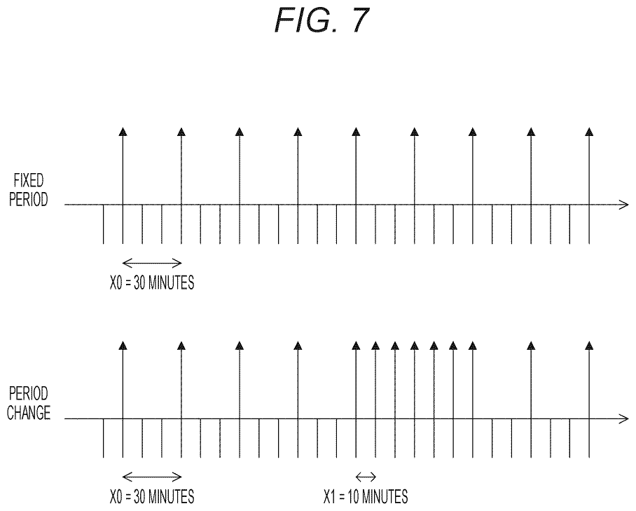

FIG. 7 is a diagram illustrating a specific example of transition of the transmission period in the first embodiment of the present technology.

As illustrated in FIG. 7, the operation is normally performed in the initial period X0 (30 minutes in this example) as the transmission period P, and when the terminal-to-satellite distance becomes smaller than the threshold TH, the operation is performed in the short period X1 (10 minutes in this example) as the transmission period P. As a result, the transmission period is made shorter in a case where the satellite receiving station 600 is present nearby, thereby improving the possibility that reception is performed in the satellite receiving station 600.

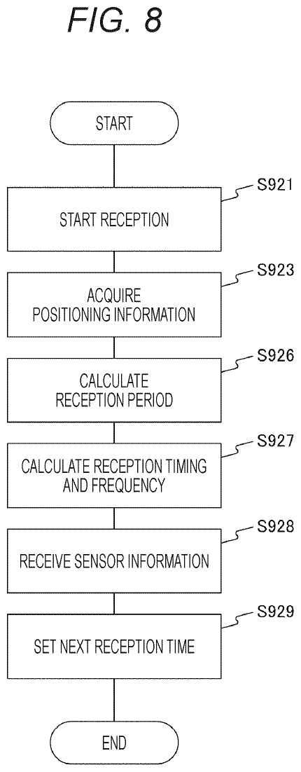

FIG. 8 is a flowchart illustrating an example of a processing procedure of the satellite receiving station 600 in the embodiment of the present technology.

It is assumed that the satellite receiving station 600 acquires the terminal identifier ID of the terminal 100 to be received and the transmission period (the initial period X0 and the short period X1) of the terminal 100 from the server 400 in advance.

The satellite receiving station 600 starts operation after power is turned on (step S921). Furthermore, the operation may be stopped or restarted from the server 400.

The receiving station positioning unit 620 receives a signal from the positioning satellite of the global navigation satellite system, and acquires the current time and the position information of the satellite receiving station 600 (step S923).

The reception period determination unit 640 determines the minimum value of the transmission periods of the terminal 100 to be received as the reception period. For example, if the initial period X0 is 30 minutes and the short period X1 is 10 minutes, 10 minutes which is the minimum value is determined as the reception period (step S926). Note that, although the operation in the case of the satellite receiving station 600 is described here, the initial period X0 is determined as the reception period in the case of the ground receiving station 200.

The wireless resource determination unit 650 determines a reception timing and a reception frequency to be used for reception from the terminal 100 on the basis of the determined reception period (step S927).

The reception control unit 690 performs control to receive the sensor information as a wireless signal according to the determined reception timing and reception frequency (step S928). The next reception time is set on the basis of the determined reception period (step S929).

As described above, according to the first embodiment of the present technology, the transmission period from the terminal 100 is set to the shorter period X1 than the normal (initial period X0) as the distance from the satellite receiving station 600 decreases, whereby the reception success rate in the satellite receiving station 600 can be improved. On the other hand, even in a case where the distance to the satellite receiving station 600 is long, the possibility of reception by the ground receiving station 200 can be secured by performing transmission in a normal transmission period.

### 2. Second Embodiment

In the first embodiment described above, the transmission period is set to the normal initial period X0 except for a case where the distance to the satellite receiving station 600 is short, but the transmission period may be set to a longer period in a case where the terminal-to-satellite distance is long. This second embodiment attempts to suppress the power consumption of the terminal 100 by setting the transmission period to a long period in a case where the terminal-to-satellite distance is longer than the threshold. Note that the configuration itself as a wireless system is similar to that of the first embodiment described above, and thus a detailed description thereof will be omitted.

### [Operation]

In the first embodiment described above, the initial period X0 and the short period X1 are assumed as the transmission period, but in the second embodiment, a long period X2 is further assumed. For example, in a case where the initial period X0 is 30 minutes and the short period X1 is 10 minutes, 60 minutes are assumed as the long period X2. These transmission periods are determined at the time of service contract, and are supplied in advance from the server 400 together with the terminal identifier of the terminal 100.

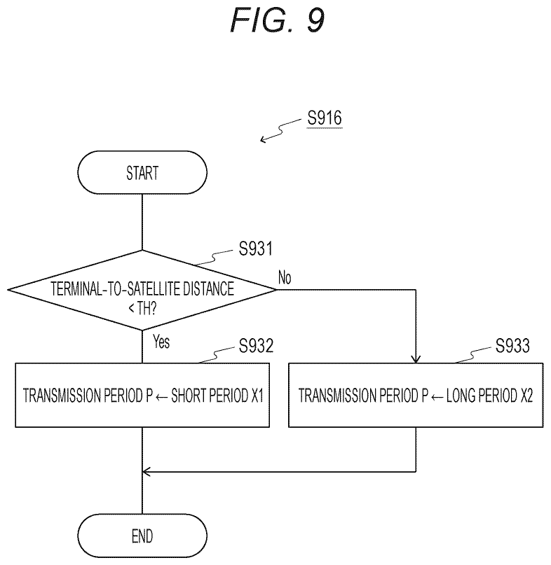

FIG. 9 is a flowchart illustrating an example of a processing procedure of a transmission period determination procedure (step S916) in the second embodiment of the present technology.

The transmission period determination unit 140 compares the terminal-to-satellite distance with the threshold TH to determine the transmission period. In a case where the terminal-to-satellite distance is not smaller than the threshold TH (step S931: No), the long period X2 is set as the transmission period P (step S933). On the other hand, when the terminal-to-satellite distance becomes smaller than the threshold TH (step S931: Yes), the short period X1 is set as the transmission period P (step S932).

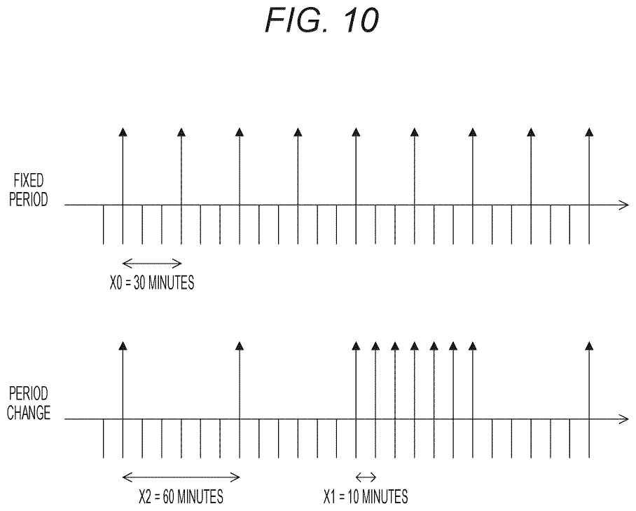

FIG. 10 is a diagram illustrating a specific example of transition of the transmission period in the second embodiment of the present technology.

As illustrated in FIG. 10, the operation is normally performed in the long period X2 (60 minutes in this example) as the transmission period P, and when the terminal-to-satellite distance becomes smaller than the threshold TH, the operation is performed in the short period X1 (10 minutes in this example) as the transmission period P. As a result, in a case where the satellite receiving station 600 is present far away, the power consumption of the terminal 100 can be suppressed by making the transmission period longer. On the other hand, in a case where the satellite receiving station 600 is present nearby, the transmission period is made shorter similarly to the above-described first embodiment, thereby improving the possibility that reception is performed in the satellite receiving station 600.

As described above, according to the second embodiment of the present technology, when the distance from the satellite receiving station 600 increases, the transmission period from the terminal 100 is set to the longer period X2 than the normal (initial period X0), whereby the power consumption of the terminal 100 can be suppressed.

### 3. Modifications

### First Modification

In the first and second embodiments of the present technology, the transmission period may be set in consideration of the battery capacity of the terminal 100. In this first modification, an example of setting the transmission period on the basis of the battery capacity of the terminal 100 will be described.

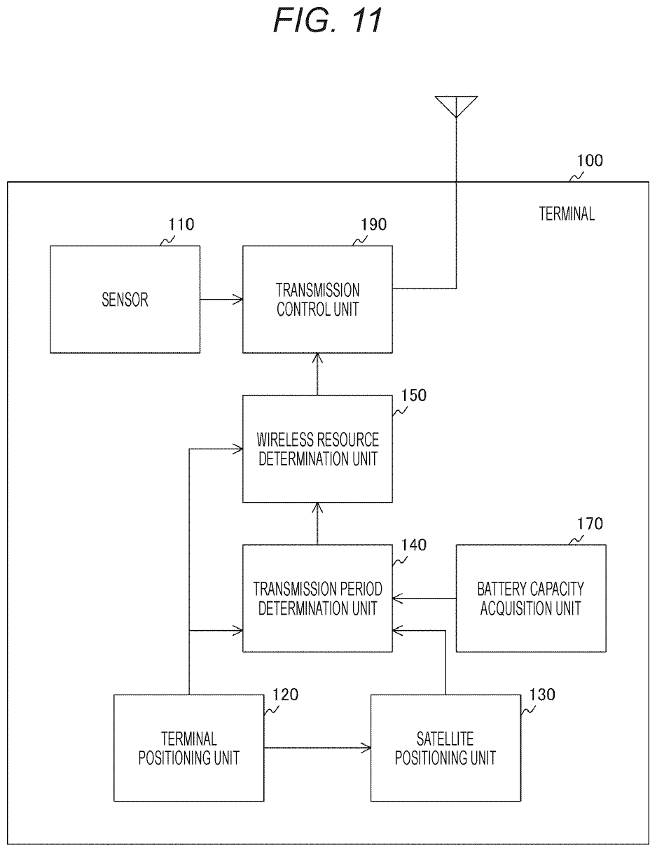

FIG. 11 is a diagram illustrating a configuration example of the terminal 100 in the first modification of the embodiments of the present technology.

The terminal 100 of the first modification further includes a battery capacity acquisition unit 170 in addition to the above-described embodiments. The battery capacity acquisition unit 170 acquires a battery capacity of a battery (not illustrated) of the terminal 100 and supplies the battery capacity to the transmission period determination unit 140.

The transmission period determination unit 140 refers to the battery capacity supplied from the battery capacity acquisition unit 170 and determines the transmission period depending on the battery capacity and the terminal-to-satellite distance. Therefore, for example, in a case where the battery capacity is smaller than the predetermined capacity threshold, a period longer than that in a case where the battery capacity is larger than the capacity threshold is determined as the transmission period. As a result, in a case where the remaining capacity of the battery is low, the transmission operation can be refrained.

Note that, when the transmission period is set, setting the transmission period to an infinite value brings a state where the transmission operation is not performed. Therefore, in a case where the remaining capacity of the battery is extremely low, the transmission operation may be stopped by setting the transmission period to an infinite value. Furthermore, in a case where the terminal-to-satellite distance is longer than a predetermined threshold, similarly, the transmission operation may be stopped by setting the transmission period to an infinite value.

### Second Modification

In the first and second embodiments of the present technology, the transmission period is switched using one threshold, but the threshold may be plural. As illustrated as the second modification, the transmission period can be switched stepwise by using a plurality of thresholds.

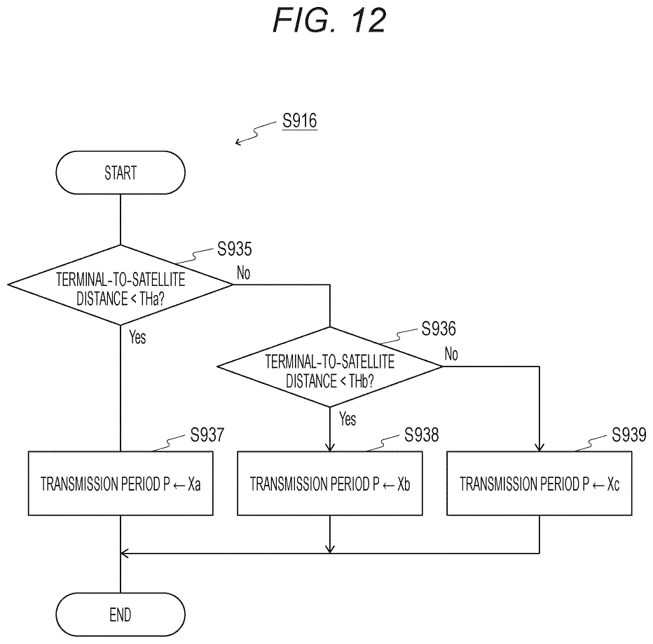

FIG. 12 is a flowchart illustrating an example of a processing procedure of a transmission period determination procedure (step S916) in the second modification of the embodiments of the present technology.

The transmission period determination unit 140 compares the terminal-to-satellite distance with a plurality of thresholds THa and THb to determine the transmission period. In a case where the terminal-to-satellite distance is smaller than the threshold THa (step S935: Yes), a period Xa is set as the transmission period P (step S937). In a case where the terminal-to-satellite distance is not smaller than the threshold THa (step S935: No), judgement is made using the threshold THb as follows (step S936).

In a case where the terminal-to-satellite distance is smaller than the threshold THb (step S936: Yes), a period Xb is set as the transmission period P (step S938). On the other hand, in a case where the terminal-to-satellite distance is not smaller than the threshold THb (step S936: No), the period Xc is set as the transmission period P (step S939).

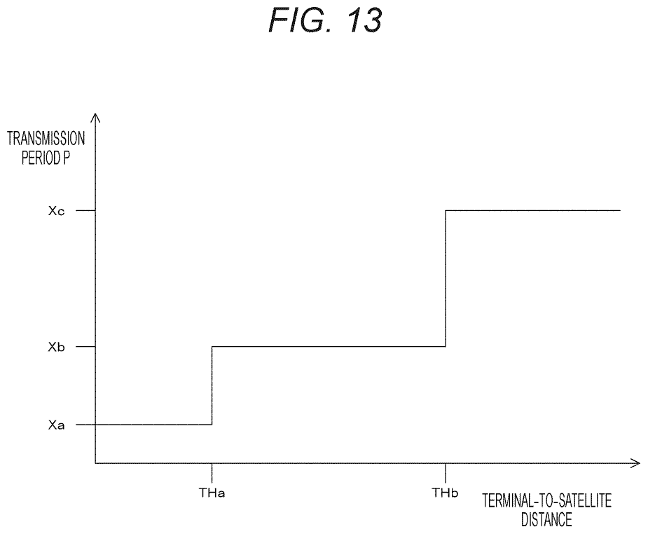

FIG. 13 is a diagram illustrating an example of a relationship between the terminal-to-satellite distance and the transmission period in the second modification of the embodiments of the present technology.

As illustrated in the drawing, in the second modification, the transmission period is switched stepwise depending on the terminal-to-satellite distance. As a result, the transmission period can be flexibly set.

Note that the embodiments described above show examples for embodying the present technology, and the matters in the embodiments and the matters specifying the invention in the claims have corresponding relationships, respectively. Similarly, the matters specifying the invention in the claims and matters with the same names in the embodiments of the present technology have correspondence relationships, respectively. However, the present technology is not limited to the embodiments, and can be embodied by applying various modifications to the embodiments without departing from the gist of the present technology.

Furthermore, the processing procedures described in the above-described embodiments may be considered as a method including a series of procedures and may be considered as a program for allowing a computer to execute the series of procedures and a recording medium which stores the program. As this recording medium, for example, a compact disc (CD), a MiniDisc (MD), a digital versatile disc (DVD), a memory card, a Blu-ray (registered trademark) disc, and the like can be used.

Note that effects described in the present specification are merely examples and are not limited, and other effects may be provided.

Note that the present technology may also have the following configuration.

(1) A terminal including:
a terminal positioning unit that acquires a terminal position that is a current position of a terminal and current time;
a satellite positioning unit that acquires a satellite position that is a current position of a satellite receiving station on the basis of the current time;
a transmission period determination unit that determines a transmission period on the basis of the terminal position and the satellite position;
a wireless resource determination unit that determines a transmission timing and a transmission frequency as wireless resources on the basis of the current time, a terminal identifier of the terminal, and the transmission period; and
a transmission control unit that controls wireless transmission in accordance with the transmission timing and the transmission frequency.

(2) The terminal according to (1),
in which the transmission period determination unit determines, as a terminal-to-satellite distance is shorter, at least a period that is not long as the transmission period, the terminal-to-satellite distance being an absolute value of a difference between the terminal position and the satellite position.

(3) The terminal according to (2),
in which, in a case where the terminal-to-satellite distance is shorter than a predetermined threshold, the transmission period determination unit determines, as the transmission period, a period shorter than a period in a case where the terminal-to-satellite distance is longer than the threshold.

(4) The terminal according to (2) or (3),
in which the transmission period determination unit determines, in a case where the terminal-to-satellite distance is shorter than a first threshold, a first period as the transmission period, the first period being shorter than a period in a case where the terminal-to-satellite distance is longer than the first threshold, and determines, in a case where the terminal-to-satellite distance is longer than the first threshold and is shorter than a second threshold that is longer than the first threshold, a second period as the transmission period, the second period being shorter than a period in a case where the terminal-to-satellite distance is longer than the second threshold.

(5) The terminal according to any one of (2) to (4),
in which the transmission period determination unit determines a predetermined initial transmission period as the transmission period at a beginning of transmission, determines a period shorter than the initial transmission period as the transmission period in a case where the terminal-to-satellite distance becomes shorter than a predetermined threshold, and determines a period longer than the initial transmission period as the transmission period in a case where the terminal-to-satellite distance becomes longer than the predetermined threshold.

(6) The terminal according to any one of (2) to (5),
in which the transmission period determination unit determines a predetermined initial transmission period as the transmission period at a beginning of transmission, determines a period shorter than the initial transmission period as the transmission period in a case where the terminal-to-satellite distance becomes shorter than a predetermined threshold, and determines a period longer than the initial transmission period as the transmission period in a case where the terminal-to-satellite distance becomes longer than the predetermined threshold.

(7) The terminal according to any one of (2) to (6),
in which, in a case where the terminal-to-satellite distance is longer than a predetermined threshold, the transmission period determination unit determines an infinite period as the transmission period.

(8) The terminal according to any one of (2) to (7), further including
a battery capacity acquisition unit that acquires a current battery capacity of a battery for operating the terminal,
in which the transmission period determination unit determines the transmission period depending on the terminal-to-satellite distance and the battery capacity.

(9) The terminal according to (8),
in which, in a case where the battery capacity is smaller than a predetermined capacity threshold, the transmission period determination unit determines, as the transmission period, a period longer than a period in a case where the battery capacity is larger than the capacity threshold.

(10) A wireless transmission control method for a terminal, the wireless transmission control method including:
a procedure of acquiring, by a terminal positioning unit, a terminal position that is a current position of a terminal and current time;
a procedure of acquiring, by a satellite positioning unit, a satellite position that is a current position of a satellite receiving station on the basis of the current time;
a procedure of determining, by a transmission period determination unit, a transmission period on the basis of the terminal position and the satellite position;
a procedure of determining, by a wireless resource determination unit, a transmission timing and a transmission frequency as wireless resources on the basis of the current time, a terminal identifier of the terminal, and the transmission period; and
a procedure of controlling, by a transmission control unit, wireless transmission in accordance with the transmission timing and the transmission frequency.

### REFERENCE SIGNS LIST

100 Terminal
110 Sensor
120 Terminal positioning unit
130 Satellite positioning unit
140 Transmission period determination unit
150 Wireless resource determination unit
170 Battery capacity acquisition unit
190 Transmission control unit
200 Ground receiving station
300 Ground control station
400 Server
500 Internet
600 Satellite receiving station
620 Receiving station positioning unit
640 Reception period determination unit
650 Wireless resource determination unit
680 Server communication unit
690 Reception control unit

1. A terminal comprising:
a terminal positioning unit that acquires a terminal position that is a current position of a terminal and current time;
a satellite positioning unit that acquires a satellite position that is a current position of a satellite receiving station on a basis of the current time;
a transmission period determination unit that determines a transmission period on a basis of the terminal position and the satellite position;
a wireless resource determination unit that determines a transmission timing and a transmission frequency as wireless resources on a basis of the current time, a terminal identifier of the terminal, and the transmission period; and
a transmission control unit that controls wireless transmission in accordance with the transmission timing and the transmission frequency.

2. The terminal according to claim 1,
wherein the transmission period determination unit determines, as a terminal-to-satellite distance is shorter, at least a period that is not long as the transmission period, the terminal-to-satellite distance being an absolute value of a difference between the terminal position and the satellite position.

3. The terminal according to claim 2,
wherein, in a case where the terminal-to-satellite distance is shorter than a predetermined threshold, the transmission period determination unit determines, as the transmission period, a period shorter than a period in a case where the terminal-to-satellite distance is longer than the threshold.

4. The terminal according to claim 2,
wherein the transmission period determination unit determines, in a case where the terminal-to-satellite distance is shorter than a first threshold, a first period as the transmission period, the first period being shorter than a period in a case where the terminal-to-satellite distance is longer than the first threshold, and determines, in a case where the terminal-to-satellite distance is longer than the first threshold and is shorter than a second threshold that is longer than the first threshold, a second period as the transmission period, the second period being shorter than a period in a case where the terminal-to-satellite distance is longer than the second threshold.

5. The terminal according to claim 2,
wherein the transmission period determination unit determines a predetermined initial transmission period as the transmission period at a beginning of transmission, determines a period shorter than the initial transmission period as the transmission period in a case where the terminal-to-satellite distance becomes shorter than a predetermined threshold, and determines the initial transmission period as the transmission period in a case where the terminal-to-satellite distance becomes longer than the predetermined threshold.

6. The terminal according to claim 2,
wherein the transmission period determination unit determines a predetermined initial transmission period as the transmission period at a beginning of transmission, determines a period shorter than the initial transmission period as the transmission period in a case where the terminal-to-satellite distance becomes shorter than a predetermined threshold, and determines a period longer than the initial transmission period as the transmission period in a case where the terminal-to-satellite distance becomes longer than the predetermined threshold.

7. The terminal according to claim 2,
wherein, in a case where the terminal-to-satellite distance is longer than a predetermined threshold, the transmission period determination unit determines an infinite period as the transmission period.

8. The terminal according to claim 2, further comprising
a battery capacity acquisition unit that acquires a current battery capacity of a battery for operating the terminal,
wherein the transmission period determination unit determines the transmission period depending on the terminal-to-satellite distance and the battery capacity.

9. The terminal according to claim 8,
wherein, in a case where the battery capacity is smaller than a predetermined capacity threshold, the transmission period determination unit determines, as the transmission period, a period longer than a period in a case where the battery capacity is larger than the capacity threshold.

10. A wireless transmission control method for a terminal, the wireless transmission control method comprising:
a procedure of acquiring, by a terminal positioning unit, a terminal position that is a current position of a terminal and current time;
a procedure of acquiring, by a satellite positioning unit, a satellite position that is a current position of a satellite receiving station on a basis of the current time;
a procedure of determining, by a transmission period determination unit, a transmission period on a basis of the terminal position and the satellite position;
a procedure of determining, by a wireless resource determination unit, a transmission timing and a transmission frequency as wireless resources on a basis of the current time, a terminal identifier of the terminal, and the transmission period; and
a procedure of controlling, by a transmission control unit, wireless transmission in accordance with the transmission timing and the transmission frequency.
